(19) United States
(12) Patent Application Publication
(10) Pub. No.: US 2026/0070156 A1
(43) Pub. Date: Mar. 12, 2026

(54) CUTTING DEVICE FOR CUTTING COMPOSITE MATERIAL

(71) Applicant: CohPros International Co., Ltd., Hsinchu City (TW)

(72) Inventors: SHIH-SHENG LIN, Kaohsiung City (TW); CHIH-WEI YU, Taipei City (TW)

(21) Appl. No.: 19/392,315

(22) Filed: Nov. 18, 2025

Related U.S. Application Data
(63) Continuation-in-part of application No. 17/747,103, filed on May 18, 2022.
Application No. 17/747,103 is a continuation-in-part of application No. 16/276,251, filed on Feb. 14, 2019, now abandoned.

(30) Foreign Application Priority Data
Aug. 1, 2018 (TW) 107210505

(51) Int. Cl. B23K 26/38; B23K 26/0622

(52) U.S. Cl. CPC B23K 26/38; B23K 26/0622

(57) ABSTRACT

A cutting device includes a carrier substrate and a laser generating module. The laser generating module includes a pulsed laser generating module, an acousto-optic modulator and a laser amplifier. The pulsed laser generating module is configured to generate a laser light source. The acousto-optic modulator is configured to increase a repetition frequency of the laser light source and generate a pulsed laser beam having a plurality of pulse trains based on the laser light source with the increased repetition frequency. The laser amplifier is configured to increase a pulse energy of the pulsed laser beam. When the pulsed laser beam with the pulse trains is projected onto the composite material, a plurality of cutting areas or drilling holes are formed on the composite material by the pulsed laser beam with the pulse trains. Each pulse train of the pulsed laser beam includes a plurality of pulse signals.

### CROSS-REFERENCE TO RELATED PATENT APPLICATION

This is a Continuation-In-Part of the U.S. application Ser. No. 17/747,103, filed on May 18, 2022 and entitled “CUTTING DEVICE FOR CUTTING COMPOSITE MATERIAL”, which is a Continuation-In-Part of the U.S. application Ser. No. 16/276,251, filed on Feb. 14, 2019 and entitled “CUTTING DEVICE FOR CUTTING COMPOSITE MATERIAL”, which claims the benefit of priority to Taiwan Patent Application No. 107210505, filed on Aug. 1, 2018, the entire disclosures of which are incorporated herein by reference.

### FIELD OF THE PRESENT DISCLOSURE

The present disclosure relates to a cutting device, and more particularly to a cutting device for cutting a composite material.

### BACKGROUND OF THE PRESENT DISCLOSURE

Existing semiconductor fabrication techniques such as wafer dicing, scribing or patterning are still primarily performed by using metal cutting blades. Such metal cutting blades can cut semiconductor materials such as gallium arsenide and silicon carbide. However, in order to avoid damaging the cutting surface, the dicing speed must be controlled within a limited range, which leads to difficulty in product capacity improvement.

On the other hand, with the continuous progress in the technology of wafer producing, the technique of forming a composite material by sputtering and depositing a layered film of various materials on the wafer surface has been developed. However, a composite material so formed has a greater thickness than existing wafers, and while the composite material can still be cut with the aid of an existing laser cutting technology, the cutting surface of the composite material can easily be deformed thereby, which affects subsequent processing.

### SUMMARY OF THE PRESENT DISCLOSURE

In response to the above-referenced technical inadequacies, the present disclosure provides a cutting device for cutting a composite material.

In one aspect, the present disclosure provides a cutting device for cutting a composite material including a carrier substrate for carrying the composite material, and a laser generating module disposed adjacent to the carrier substrate, in which the laser generating module includes a pulsed laser generating module, an acousto-optic modulator adjacent to the pulsed laser generating module, and a laser amplifier adjacent to the acousto-optic modulator. The pulsed laser generating module is configured to generate a laser light source. The acousto-optic modulator is configured to increase a repetition frequency of the laser light source and generate a pulsed laser beam having a plurality of pulse trains based on the laser light source with the increased repetition frequency. The laser amplifier is configured to increase a pulse energy of the pulsed laser beam. When the pulsed laser beam with the pulse trains is projected onto the composite material, a plurality of cutting areas or drilling holes are formed on the composite material by the pulsed laser beam with the pulse trains. Each of the pulse trains of the pulsed laser beam includes a plurality of pulse signals, the number of the pulse signals in each of the pulse trains is between 50 and 1000, a pulse width of each of the pulse trains is between 50 and 500 fs, and a frequency of each of the pulse trains is between 1 and 2000 kHz. The pulse trains provided by the pulsed laser beam are configured to be identical or different according to the number of the pulse signals in each of the pulse trains, and the pulse width and the frequency of each of the pulse trains.

In another aspect, the present disclosure provides a cutting device for cutting a composite material including a carrier substrate for carrying the composite material, and a laser generating module disposed adjacent to the carrier substrate, in which the laser generating module includes a pulsed laser generating module, an acousto-optic modulator adjacent to the pulsed laser generating module, and a laser amplifier adjacent to the acousto-optic modulator. The pulsed laser generating module is configured to generate a laser light source. The acousto-optic modulator is configured to increase a repetition frequency of the laser light source and generate a pulsed laser beam having a plurality of pulse trains based on the laser light source with the increased repetition frequency. The laser amplifier is configured to increase a pulse energy of the pulsed laser beam. When the pulsed laser beam with the pulse trains is projected onto the composite material, a plurality of cutting areas or drilling holes are formed on the composite material by the pulsed laser beam with the pulse trains. Each of the pulse trains of the pulsed laser beam includes a plurality of pulse signals. The pulse trains provided by the pulsed laser beam are configured to be identical or different according to the number of the pulse signals in each of the pulse trains, and a pulse width and a frequency of each of the pulse trains.

These and other aspects of the present disclosure will become apparent from the following description of certain embodiments taken in conjunction with the following drawings and their captions, although variations and modifications therein may be affected without departing from the spirit and scope of the novel concepts of the present disclosure.

### BRIEF DESCRIPTION OF THE DRAWINGS

The present disclosure will become more fully understood from the detailed description and the accompanying drawings, in which:

FIG. 1 is a schematic structural view of a cutting device for cutting a composite material according to a first embodiment of the present disclosure.

FIG. 2 is a schematic structural view of a laser scanning writer of the cutting device for cutting the composite material according to the first embodiment of the present disclosure.

FIG. 3 is a first top view of the cutting device for cutting the composite material forming a cutting area on the composite material by a laser beam according to the first embodiment of the present disclosure.

FIG. 4 is a second top view of the cutting device for cutting the composite material forming the cutting area on the composite material by the laser beam according to the first embodiment of the present disclosure.

FIG. 5 is a third top view of the cutting device for cutting the composite material forming the cutting area on the composite material by the laser beam according to the first embodiment of the present disclosure.

FIG. 6 is a fourth top view of the cutting device for cutting the composite material forming a cutting area on the composite material by a laser beam according to the first embodiment of the present disclosure.

FIG. 7 is a fifth top view of the cutting device for cutting the composite material forming a cutting area on the composite material by a laser beam according to the first embodiment of the present disclosure.

FIG. 8 is a first schematic view of the cutting device cutting the composite material by the laser beam according to the first embodiment of the present disclosure.

FIG. 9 is a second schematic view of the cutting device cutting the composite material by the laser beam according to the first embodiment of the present disclosure.

FIG. 10 is a third schematic view of the cutting device cutting the composite material by the laser beam according to the first embodiment of the present disclosure.

FIG. 11 is a fourth schematic view of the composite material cut by the laser beam of the cutting device according to the first embodiment of the present disclosure.

FIG. 12 is a first schematic view of the cutting device cutting the composite material by a laser beam according to a second embodiment of the present disclosure.

FIG. 13 is a second schematic view of the cutting device cutting the composite material by a laser beam according to the second embodiment of the present disclosure.

FIG. 14 is a third schematic view of the cutting device cutting the composite material by a laser beam according to the second embodiment of the present disclosure.

FIG. 15 is a fourth schematic view of the composite material cut by the laser beam of the cutting device according to the second embodiment of the present disclosure.

FIG. 16 is a schematic top view of the cutting device for forming the cutting area on the composite material by the laser beam and for cleaning the particles from the groove according to a third embodiment of the present disclosure.

FIG. 17 is a schematic lateral view of the composite material that is cut by the laser beam of the cutting device and is cleaned by using the air blowing and suction module (to remove particles) according to the third embodiment of the present disclosure.

FIG. 18 is a schematic lateral view of the composite material that is cut by the laser beam of the cutting device and is cleaned by using the air blowing and suction module (to remove particles) according to a fourth embodiment of the present disclosure.

FIG. 19 is a schematic lateral view of the composite material that is cut by the laser beam of the cutting device and is cleaned by using the air blowing and suction module (to remove particles) according to a fifth embodiment of the present disclosure.

FIG. 20 is a schematic lateral view of the composite material that is cut by the laser beam of the cutting device and is cleaned by using the air blowing and suction module (to remove particles) according to a sixth embodiment of the present disclosure.

FIG. 21 is a schematic lateral view of the composite material that is cut by the laser beam of the cutting device and is cleaned by using the air blowing and suction module (to remove particles) according to a seventh embodiment of the present disclosure.

FIG. 22 is a schematic view of the laser generating module including a pulsed laser generating module, an acousto-optic modulator and a laser amplifier according to an eighth embodiment of the present disclosure.

FIG. 23 is a schematic view of each pulse train of the pulsed laser beam including a plurality of pulse signals according to the eighth embodiment of the present disclosure.

FIG. 24 is a schematic view of the optical detection module including a light-emitting unit, a first light-receiving unit and a second light-receiving unit according to a ninth embodiment of the present disclosure.

FIG. 25 is a schematic view of each drilling hole that is filled with a micro conductive pillar by cooperation of a vibration module and a magnetic field generation module according to a tenth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

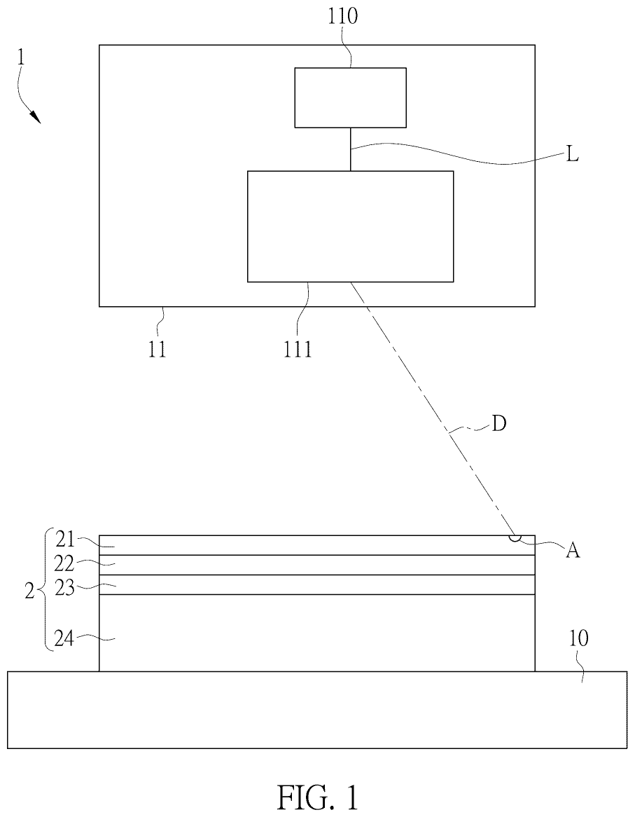

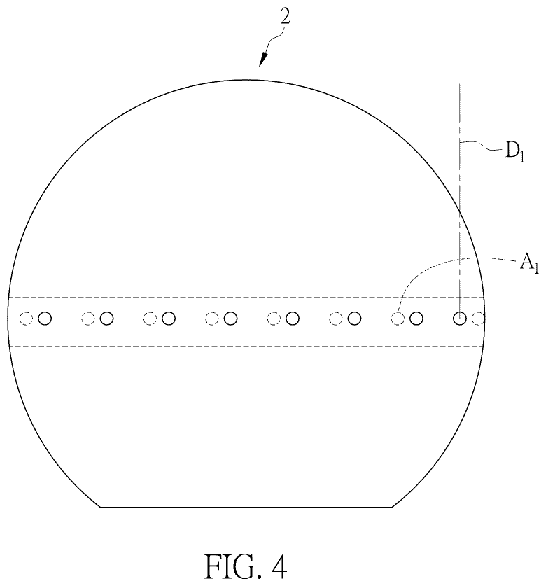

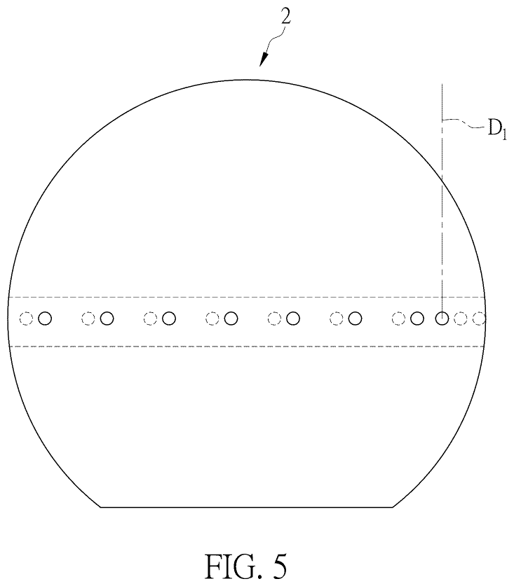

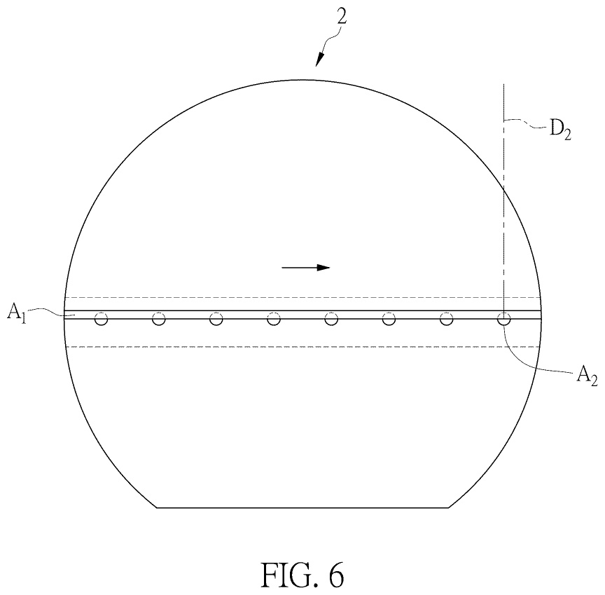

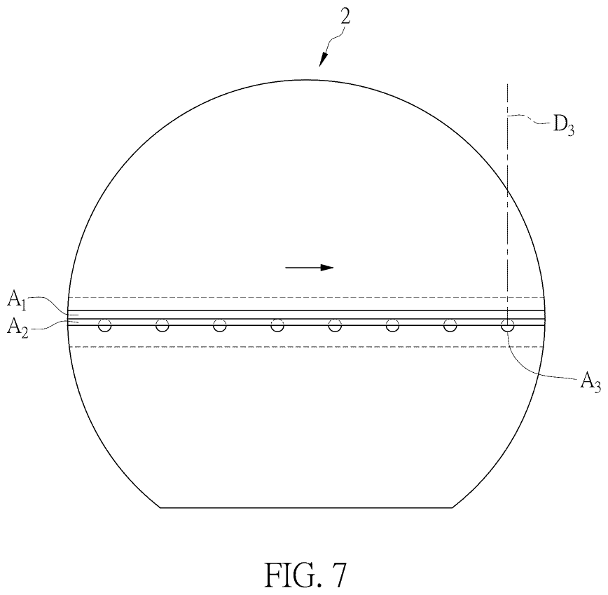

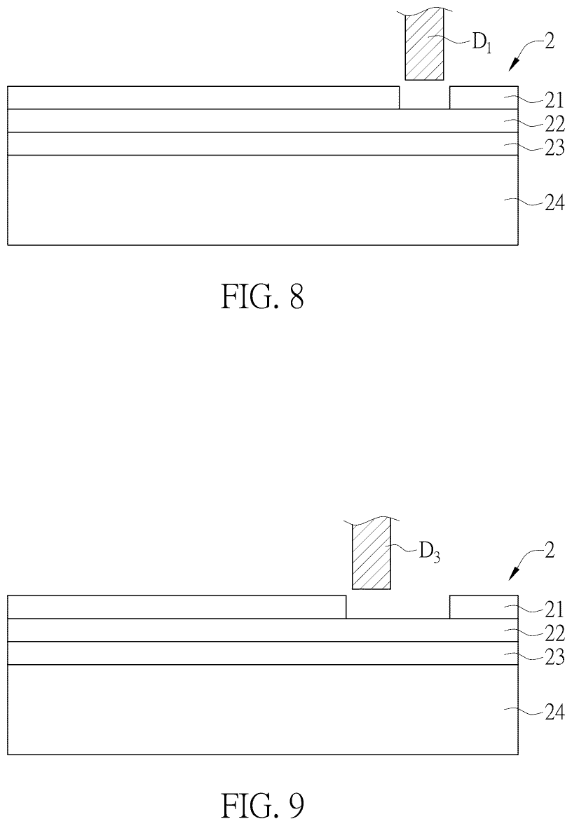

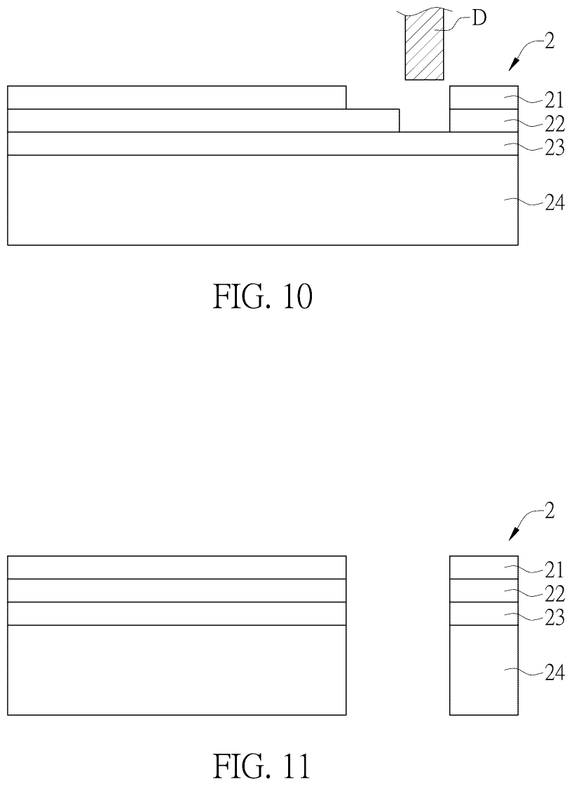

Reference is made to FIG. 1 to FIG. 11, which are respectively a schematic structural view of a cutting device 1 for cutting a composite material 2 according to a first embodiment of the present disclosure, a schematic structural view of a laser scanning writer 110 of the cutting device 1 for cutting the composite material 2 according to the first embodiment of the present disclosure, the first to fifth top views of the cutting device 1 for cutting the composite material 2 forming cutting areas A₁ to A₃ on the composite material 2 by laser beams D₁ to D₃ according to the first embodiment of the present disclosure, and the first to fourth schematic views of the cutting device cutting the composite material by a laser beam according to the first embodiment of the present disclosure. As shown in the figures, the first embodiment of the present disclosure provides a cutting device 1 for cutting a composite material 2, which includes a carrier substrate 10 and a laser generating module 11. The carrier substrate 10 is used to carry the composite material 2. The laser generating module 11 is configured to provide a laser beam D. The laser generating module 11 includes a laser scanning writer 110 for providing a laser source L and a laser path adjuster 111 located on the scanning path of the laser source L. The scanning path of the laser beam D can be adjusted by the laser path adjuster 111, or the composite material 2 can be carried and moved by the carrier substrate 10, such that a cutting area A formed by projecting the laser beam D onto the composite material 2 is offset parallel.

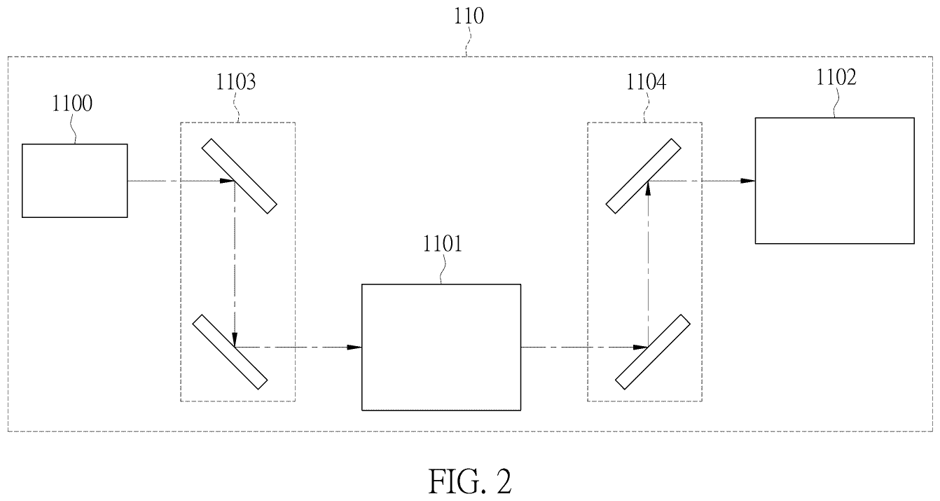

Specifically, the cutting device 1 for cutting the composite material 2 of the present disclosure includes the carrier substrate 10 and the laser generating module 11. The carrier substrate 10 can be a carrier of a general cutting device and is used to carry an object to be cut. The object to be cut is exemplified as the composite material 2 in this embodiment. However, the present disclosure is not limited thereto. The laser generating module 11 can provide a laser beam D for cutting the composite material 2. The laser generating module 11 includes the laser scanning writer 110 and the laser path adjuster 111. The laser scanning writer 110 is a light source device for providing the laser source L, and the laser path adjuster 111 can be located on the scanning path of the laser source L. Furthermore, as shown in FIG. 2, the laser scanning writer 110 can include a laser generating unit 1100, a beam expanding unit 1101, a polygonal rotating mirror unit 1102, a first mirror set 1103, and a second mirror set 1104. The laser generating unit 1100 can provide the laser source L with a pulse width on the order of femtoseconds (10⁻¹⁵ seconds, fs), which can be less than 500 fs, and the pulse repetition rate (frequency) of the laser source L can be greater than, but not limited to, 1 MHz, so as to maintain a small heat affected zone (HAZ), which effectively improves the precision of laser processing. The laser source L can be an adjustable wavelength laser source, which changes according to the material of the object to be cut (such as the composite material 2). The polygonal rotating mirror unit 1102 can be a polygonal reflection mirror structure having a plurality of reflecting surfaces. The beam expanding unit 1101 is located between the laser generating unit 1100 and the polygonal rotating mirror unit 1102 for changing the diameter of the light beam of the laser source L, for example, enlarging the light beam of the laser source L. Furthermore, a first mirror set 1103 is disposed between the laser generating unit 1100 and the beam expanding unit 1101, and a second mirror set 1104 is disposed between the polygonal rotating mirror unit 1102 and the beam expanding unit 1101. Therefore, after the light beam of the laser source L is supplied from the laser light generating unit 1100, the light beam of the laser source L is projected to the beam expanding unit 1101 by the reflection of the first mirror set 1103. Next, the size of the light beam of the laser source L is selectively adjusted or maintained by the beam expanding unit 1101, and reflected by the second mirror set 1104 to be projected to the polygonal rotating mirror unit 1102. Finally, as the polygonal rotating mirror unit 1102 rotates, the light beam of the laser source L is sequentially projected on different reflection surfaces of the polygonal rotating mirror unit 1102. The reflection surfaces rotate to be displaced within a unit time per rotation of the polygonal rotating mirror unit 1102. Therefore, incident lights having different angles and their corresponding reflection lights having different angles can be generated from the light beam of the laser source L within a unit time. That is, as the polygonal rotating mirror unit 1102 continues rotating, the light beam of the laser source L can be sequentially and repeatedly reflected by the plurality of reflecting surfaces and then be projected out.

Therefore, before performing the cutting operation, the cutting device 1 for cutting the composite material 2 according to the present disclosure can have the composite material 2 placed on the carrier substrate 10, and in the present embodiment, the composite material 2 can be a composite structure formed by covering multiple layers of materials (such as an oxide layer 21, a nitride layer 22 and a carbonization layer 23, etc.) on a substrate 24 (for example, a semiconductor wafer having a thickness of less than 100 μm). However, the present disclosure is not limited thereto.

Next, during the cutting operation, through the laser generating module 11, the cutting device 1 for cutting the composite material 2 according to the present disclosure can repeatedly project the laser beam D toward the composite material 2 on the carrier substrate 10 to form a plurality of cutting areas A on the composite material 2. In the present embodiment, when the laser generating module 11 repeatedly projects the laser beam D onto the composite material 2, the cutting device 1 for cutting the composite material 2 can adjust the scanning path of the laser beam D through the laser path adjuster 111, so that the laser beam D can be offset parallel to form the cutting areas A at different positions on the composite material 2. That is, the laser beam D can be adjusted by the laser path adjuster 111 to have a parallel offset relative to the composite material 2.

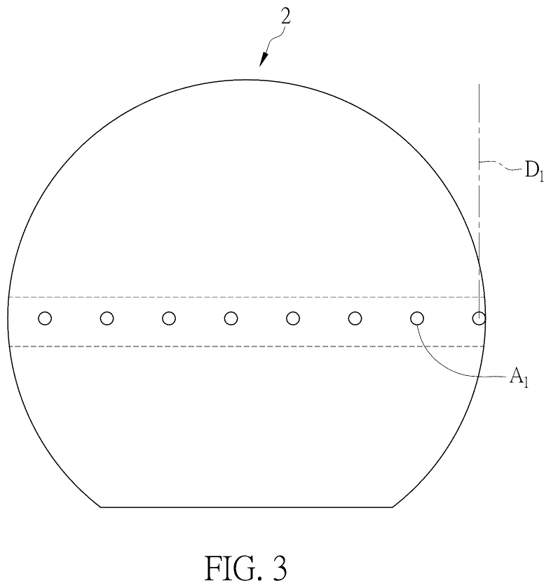

Furthermore, as shown in FIG. 3 to FIG. 11, after the laser generating module 11 projects a laser beam D₁ to the composite material 2, a cutting area A₁ is formed on the composite material 2. Then, when the laser generating module 11 projects a laser beam D₂ to the composite material 2, the laser path adjuster 111 adjusts the scanning path of laser beam D₂, so as to cause a cutting area A₂ formed on the composite material 2 by the laser beam D₂ to be at a different position from that of the cutting area A₁, while still partially overlapping therewith. When the laser generating module 11 projects a laser beam D₃ onto the composite material 2, through the adjustment by the laser path adjuster 111, a cutting area A₃ formed by the laser beam D₃ on the composite material 2 can also be located at a different position from that of the cutting areas A₁ and A₂, while still partially overlapping with the cutting area A₂.

As stated above, the cutting process can be defined as the first cutting process conducted by the laser generating module 11, while the laser generating module 11 can also perform a second cutting process, in which a position of the cutting area(s) A formed by the projection of the laser beam D on the composite material 2 can be the same as that of the cutting area A₁ or the cutting area A₃, and the number of the cutting area(s) A formed by the laser generating module 11 during the second cutting process can be the same as that in the first cutting process. Therefore, the cutting device 1 for cutting the composite material 2 according to the present disclosure can perform a plurality of cutting processes by the laser generating module 11, and adjust the scanning path of the laser beam D by the laser path adjuster 111 to gradually deepen the cutting depth of the laser beam D, so as to cut through the composite material 2.

Therefore, the cutting device 1 for cutting the composite material 2 according to the present disclosure can repeatedly and continuously project a plurality of laser beams D by the laser generating module 11, and adjust the scanning paths of the laser beams D by the laser path adjuster 111, so as to form a plurality of cutting areas A on the composite material 2, and gradually deepen the cutting depth to cut through the composite material 2.

In the above embodiment, the laser source L can be infrared light (IR) laser, ultraviolet light (UV) laser, or green laser. However, the present disclosure is not limited thereto.

### second Embodiment

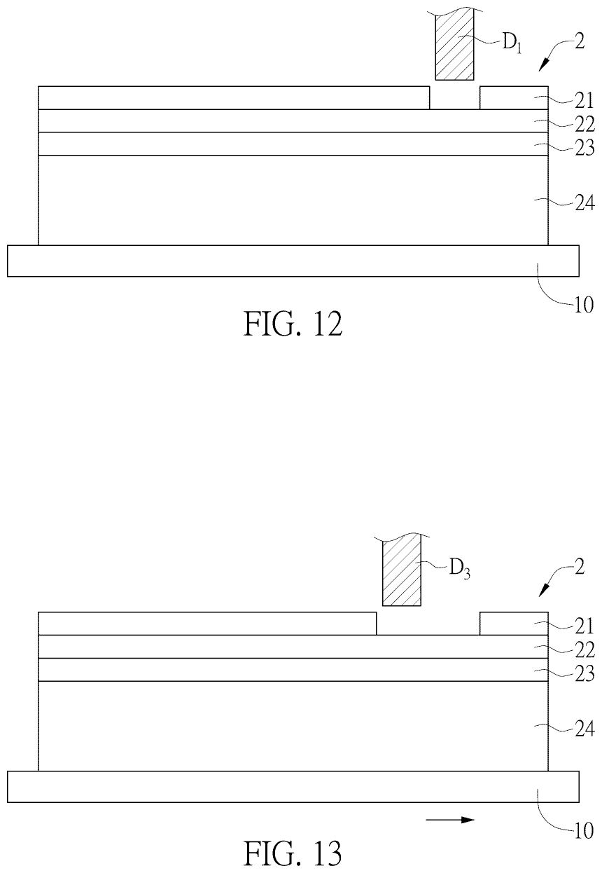

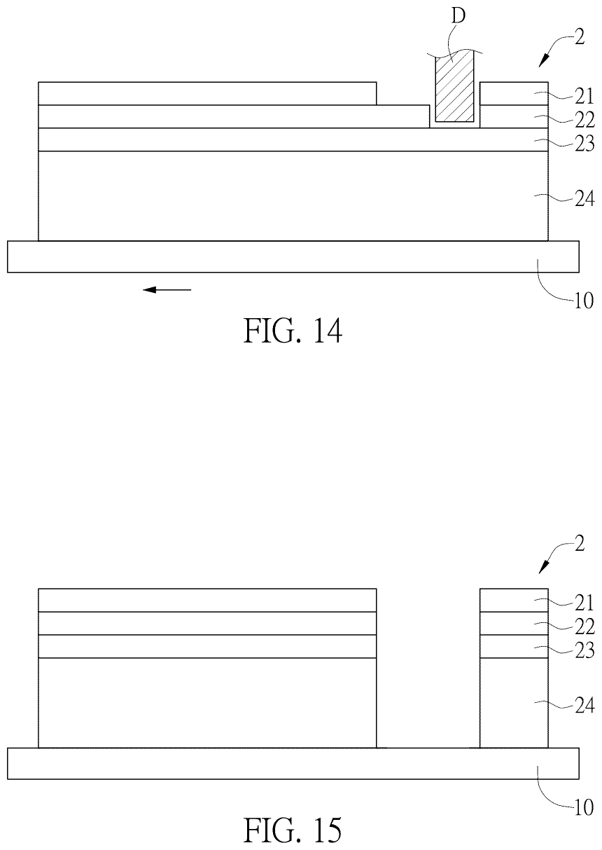

Reference is made to FIG. 12 to FIG. 15, which include the first to fourth schematic views of the cutting device 1 cutting the composite material 2 by a laser beam according to a second embodiment of the present disclosure. Reference is also made to FIG. 1 to FIG. 11. As shown in the figures, in the present embodiment, the composite material 2 is offset parallel relative to the laser generating module 11 through the moving of the carrier substrate 10. Furthermore, a portion of the laser beam D is projected at the same position of the composite material 2, while another portion of the laser beam D is projected at different locations of the composite material 2.

The structure and the operation principle of the cutting device 1 for cutting the composite material 2 of the present embodiment are similar to that of the first embodiment, and the cutting device 1 for cutting the composite material 2 of the present embodiment also includes the carrier substrate 10 and the laser generating module 11. The carrier substrate 10 can be a carrier of a general cutting device and is used to carry the object to be cut. The object to be cut is exemplified as the composite material 2 in this embodiment. However, the present disclosure is not limited thereto. The laser generating module 11 can provide a laser beam D for cutting the composite material 2. The laser generating module 11 includes the laser scanning writer 110 and the laser path adjuster 111. The laser scanning writer 110 is a light source device for providing the laser source L with a pulse width on the order of femtoseconds, which can be less than 500 fs, and the pulse repetition rate (frequency) of the laser source L can be greater than, but not limited to, 1 MHz. The laser path adjuster 111 can be located on the scanning path of the laser source L.

Therefore, before performing the cutting operation, the cutting device 1 for cutting the composite material 2 according to the present embodiment can have the composite material 2 placed on the carrier substrate 10, and the composite material 2 can be a composite structure formed by covering multiple layers of materials (such as the oxide layer 21, the nitride layer 22 and the carbonization layer 23, etc.) on the substrate 24 (for example, a semiconductor wafer having a thickness of less than 100 μm). However, the present disclosure is not limited thereto.

One of the differences between the cutting device 1 for cutting the composite material 2 of the present embodiment and that of the foregoing first embodiment is that, when the cutting device 1 of the present embodiment performs cutting, the composite material 2 can be offset parallel relative to the laser generating module 11 through the moving of the carrier substrate 10, so that the cutting area A formed by projecting the laser beam D onto the composite material 2 is offset parallel, and a plurality of laser beams D are sequentially projected onto the composite material 2 to cut the composite material 2.

Furthermore, when performing cutting, the cutting device 1 for cutting the composite material 2 according to the present disclosure can repeatedly project the laser beam D by the laser generating module 11 onto the composite material 2 on the carrier substrate 10, and form a plurality of cutting areas A on the composite material 2. In the present embodiment, during the process of the laser generating module 11 repeatedly projecting the laser beam D to the composite material 2, the composite material 2 is offset parallel relative to the laser generating module 11 by the moving of the composite material 2 and the carrier substrate 10, so that the laser beam D can be offset parallel, thereby forming the cutting area A at different positions on the composite material 2.

Furthermore, as shown in FIG. 3 to FIG. 7 and FIG. 12 to FIG. 15, after the laser generating module 11 projects the laser beam D₁ to the composite material 2, the laser beam D₁ forms a cutting area A₁ on the composite material 2. Then, when the laser generating module 11 projects the laser beam D₂ to the composite material 2, the composite material 2 is carried and moved by the carrier substrate 10, and the cutting area A₂ formed by the laser beam D₂ on the composite material 2 is located at a position different from that of the cutting area A₁, while still partially overlapping therewith. When the laser generating module 11 projects the laser beam D₃ to the composite material 2, the composite material 2 is carried and moved by the carrier substrate 10, and the cutting area A₃ formed by the laser beam D₃ on the composite material 2 is located at a position different from that of the cutting areas A₁ and A₂, while still partially overlapping with that of the cutting area A₂. The afore-referenced cutting process can be defined as the first cutting process conducted by the laser generating module 11, while the laser generating module 11 can also perform a second cutting process, that is, a position of the cutting area(s) A formed by the projection of the laser beam D on the composite material 2 can be the same as that of the cutting area A₁ or the cutting area A₃, and the number of the cutting area(s) A formed by the laser generating module 11 during the second cutting process can be the same as that in the first cutting process. Therefore, the cutting device 1 for cutting the composite material 2 according to the present disclosure can perform a plurality of cutting processes by the laser generating module 11, and adjust the scanning path of the laser beam D by the laser path adjuster 111 to gradually deepen the cutting depth of the laser beam D, so as to cut through the composite material 2.

Therefore, the cutting device 1 for cutting the composite material 2 according to the present disclosure can repeatedly and continuously project a plurality of laser beams D by the laser generating module 11, and adjust the scanning paths of the laser beams D by the laser path adjuster 111, so as to form a plurality of cutting areas A on the composite material 2, and gradually deepen the cutting depth to cut through the composite material 2.

In the above embodiment, the laser source L can be IR, UV or green laser. However, the present disclosure is not limited thereto.

### Third Embodiment

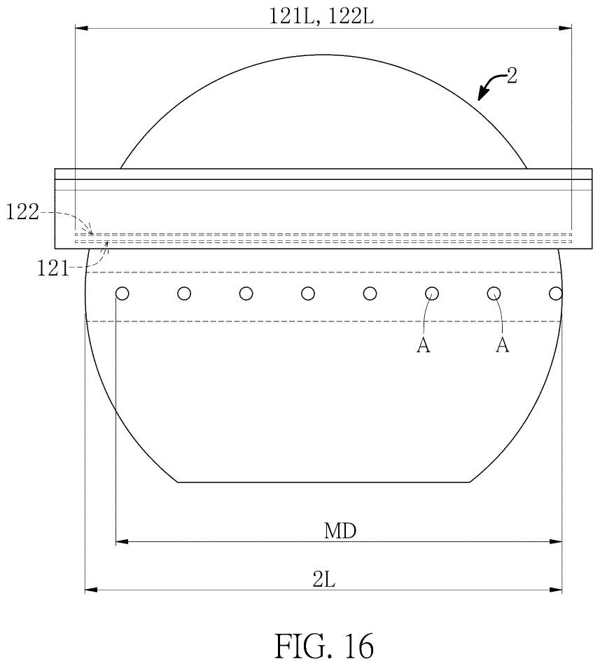

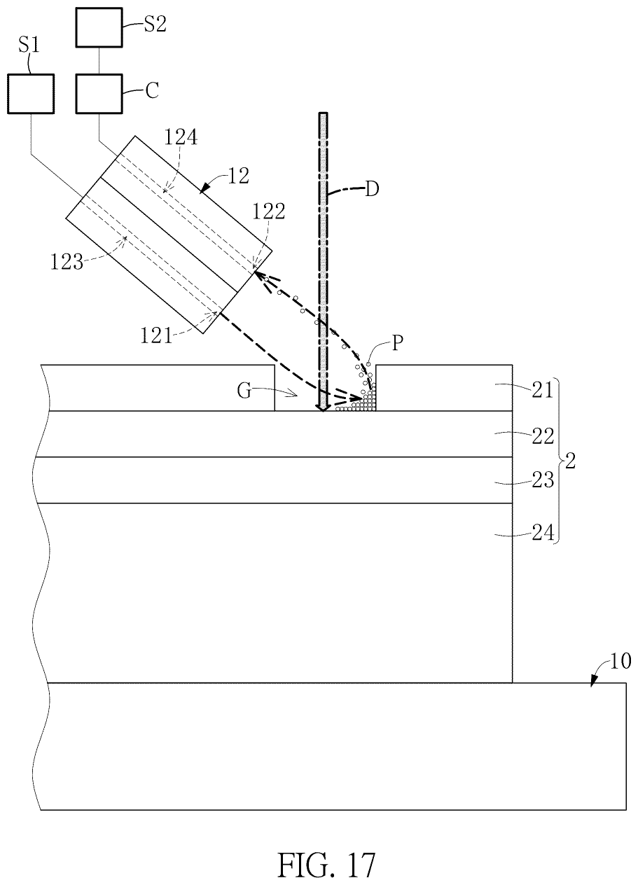

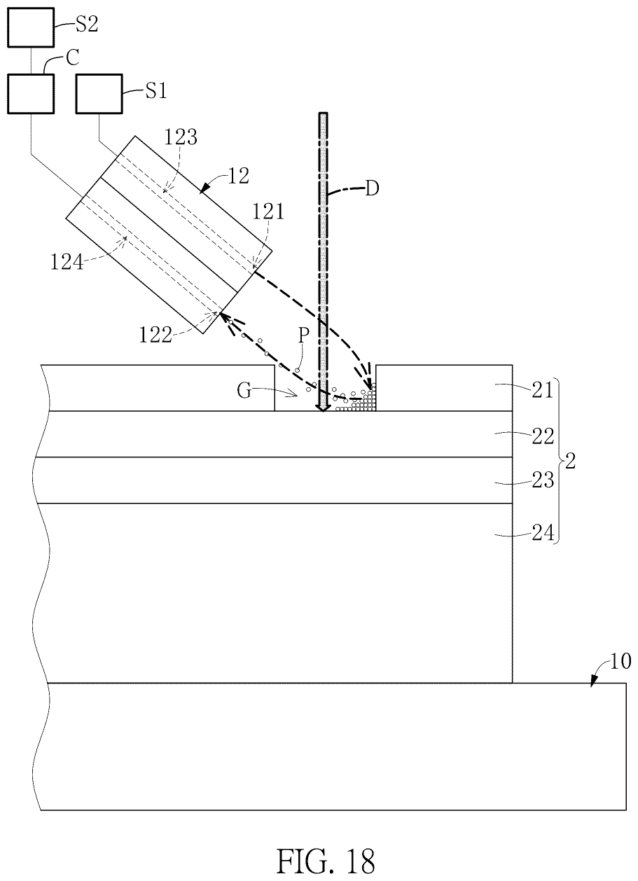

Referring to FIG. 16 and FIG. 17, the third embodiment of the present disclosure provides a cutting device (the same as the cutting device 1 of the first embodiment as shown in FIG. 1), which includes a carrier substrate 10, a laser generating module (the same as the laser generating module 11 of the first embodiment as shown in FIG. 1), and an air blowing and suction module 12 (such as a gas ejection and particle suction module). The carrier substrate 10 can be configured for carrying a composite material 2. The laser generating module 11 can be configured to project a laser beam D onto the composite material 2 for generating a plurality of cutting areas A (such as laser cut holes or laser processed areas) arranged along a predetermined direction. The air blowing and suction module 12 has a long blowing slot 121 (such as a long narrow air outlet) configured to blow air to the cutting areas A (as shown by a downward dotted arrow in FIG. 17), and a long suction slot 122 (such as a long narrow air inlet) configured to suction the air (as shown by an upward dotted arrow in FIG. 17) from the cutting areas A at the same time. That is to say, the air blowing and suction module 12 can concurrently use the long blowing slot 121 for blowing the air to the cutting areas A, and use the long suction slot 122 for suctioning the air from the cutting areas A. It should be noted that the position of the long suction slot 122 can be disposed above the position of the long blowing slot 121. It should be noted that the air blowing and suction module 12 can be configured to be separated from the composite material 2 without directly or indirectly (such as via a carrying film) causing movement of the composite material 2.

More particularly, as shown in FIG. 16, a length 121L of the long blowing slot 121 or a length 122L of the long suction slot 122 is greater than a maximum distance MD between two of the cutting areas A that are farthest apart along the predetermined direction. For example, the length 121L of the long blowing slot 121 and the length 122L of the long suction slot 122 can be the same or different, and the length 121L of the long blowing slot 121 or the length 122L of the long suction slot 122 is greater than a length 2L of the composite material 2. Hence, the length 121L of the long blowing slot 121 and the length 122L of the long suction slot 122 can cover all of the cutting areas so as to blow the air to all of the cutting areas A and suction the air from all of the cutting areas A. However, the aforementioned details are disclosed for exemplary purposes only, and are not meant to limit the scope of the present disclosure.

More particularly, as shown in FIG. 17, the air blowing and suction module 12 has a first air channel 123 in air communication with the long blowing slot 121 and an air supply device S1, and a second air channel 124 in air communication with the long suction slot 122 and a suction pump S2, and a dust collector C is in air communication with the second air channel 124 and the suction pump S2. Hence, when the air supply device S1 is turned on, the air blowing and suction module 12 can use the long blowing slot 121 to blow the air to the cutting areas A. When the suction pump S2 is turned on, the air blowing and suction module 12 can use the long suction slot 122 to suction (remove) the air with particles P from the cutting areas A, and the particles P can be collected by the dust collector C.

More particularly, as shown in FIG. 17, the cutting area A has a groove G recessed from a top surface of the composite material 2. The long blowing slot 121 of the air blowing and suction module 12 can be configured to blow the air into the groove G of each of the cutting areas A so as to blow the particles P out of the groove G of each of the cutting areas A, and the long suction slot 122 of the air blowing and suction module 12 can be configured to suction the air with the particles P (to remove the particles) from the groove G of each of the cutting areas A, so that the chance of the particles P accumulating in the grooves G is greatly reduced.

### Fourth Embodiment

Referring to FIG. 18, the fourth embodiment of the present disclosure provides a cutting device (the same as the cutting device 1 of the first embodiment as shown in FIG. 1), which includes a carrier substrate 10, a laser generating module (the same as the laser generating module 11 of the first embodiment as shown in FIG. 1), and an air blowing and suction module 12 (such as a gas ejection and particle suction module). Comparing FIG. 18 with FIG. 17, the main difference between the fourth embodiment and the third embodiment is as follows: in the fourth embodiment, the air blowing and suction module 12 has a long blowing slot 121 (such as a long narrow air outlet) configured to blow air to the cutting areas A (as shown by a downward dotted arrow in FIG. 18), and a long suction slot 122 (such as a long narrow air inlet) configured to suction the air (as shown by an upward dotted arrow in FIG. 18) from the cutting areas A at the same time, and the position of the long suction slot 122 can be disposed below the position of the long blowing slot 121.

### fifth Embodiment

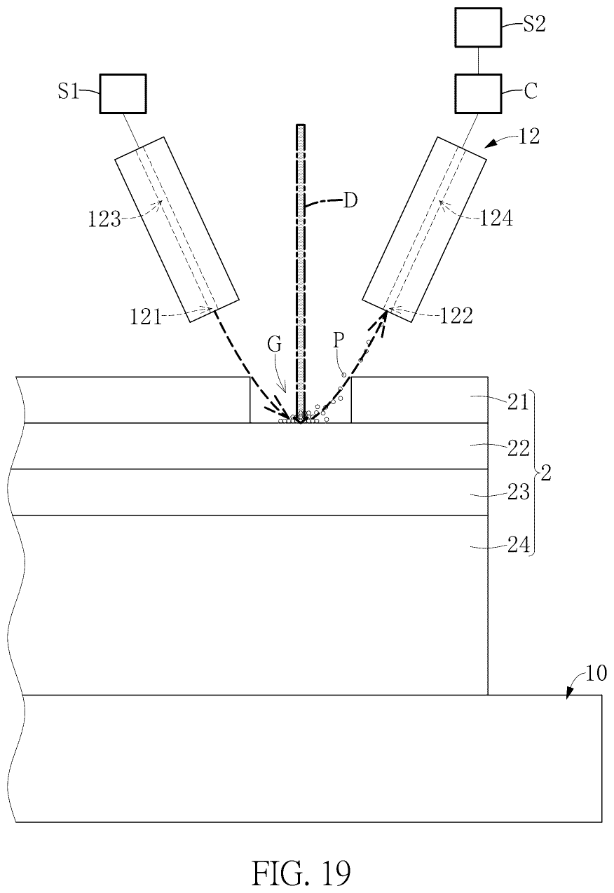

Referring to FIG. 19, the fifth embodiment of the present disclosure provides a cutting device (the same as the cutting device 1 of the first embodiment as shown in FIG. 1), which includes a carrier substrate 10, a laser generating module (the same as the laser generating module 11 of the first embodiment as shown in FIG. 1), and an air blowing and suction module 12 (such as a gas ejection and particle suction module). Comparing FIG. 19 with FIG. 17, the main difference between the fifth embodiment and the third embodiment is as follows: in the fifth embodiment, the air blowing and suction module 12 has a long blowing slot 121 (such as a long narrow air outlet) configured to blow air to the cutting areas A (as shown by a downward dotted arrow in FIG. 19), and a long suction slot 122 (such as a long narrow air inlet) configured to suction the air (as shown by an upward dotted arrow in FIG. 19) from the cutting areas A at the same time, and the long blowing slot 121 and the long suction slot 122 are respectively disposed on two separate parts of the air blowing and suction module 12.

### Sixth Embodiment

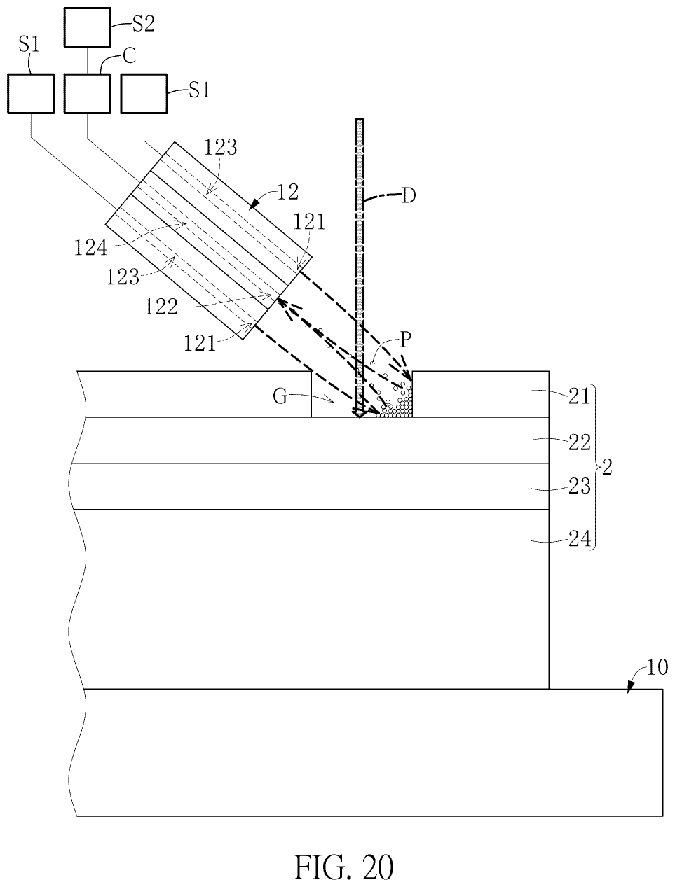

Referring to FIG. 20, the sixth embodiment of the present disclosure provides a cutting device (the same as the cutting device 1 of the first embodiment as shown in FIG. 1), which includes a carrier substrate 10, a laser generating module (the same as the laser generating module 11 of the first embodiment as shown in FIG. 1), and an air blowing and suction module 12 (such as a gas ejection and particle suction module). Comparing FIG. 20 with FIG. 17, the main difference between the sixth embodiment and the third embodiment is as follows: in the sixth embodiment, the air blowing and suction module 12 has two long blowing slots 121 (such as two long narrow air outlets) configured to blow air to the cutting areas A (as shown by two downward dotted arrows in FIG. 20), and a long suction slot 122 (such as a long narrow air inlet) configured to suction the air (as shown by an upward dotted arrow in FIG. 20) from the cutting areas A at the same time. It should be noted that the long suction slot 122 is disposed between the two long blowing slots 121, and the two long blowing slots 121 and the long suction slot 122 can be disposed on the same part of the air blowing and suction module 12 or respectively disposed on three separate parts of the air blowing and suction module 12.

### Seventh Embodiment

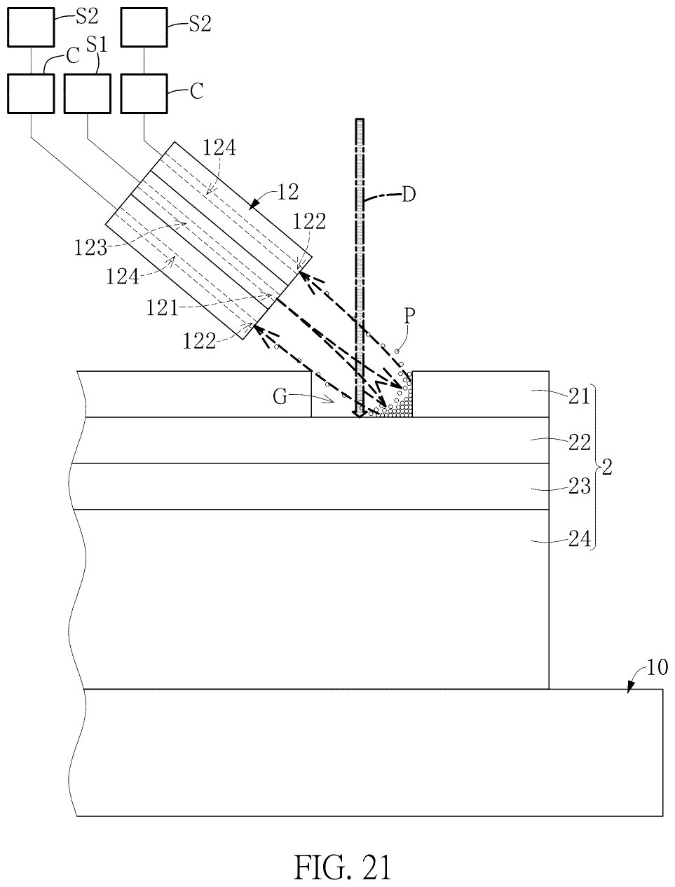

Referring to FIG. 21, the seventh embodiment of the present disclosure provides a cutting device (the same as the cutting device 1 of the first embodiment as shown in FIG. 1), which includes a carrier substrate 10, a laser generating module (the same as the laser generating module 11 of the first embodiment as shown in FIG. 1), and an air blowing and suction module 12 (such as a gas ejection and particle suction module). Comparing FIG. 21 with FIG. 17, the main difference between the seventh embodiment and the third embodiment is as follows: in the seventh embodiment, the air blowing and suction module 12 has a long blowing slot 121 (such as a long narrow air outlet) configured to blow air to the cutting areas A (as shown by a downward dotted arrow in FIG. 21), and two long suction slots 122 (such as two long narrow air inlets) configured to suction the air (as shown by two upward dotted arrows in FIG. 21) from the cutting areas A at the same time. It should be noted that the long blowing slot 121 is disposed between the two long suction slots 122, and the long blowing slot 121 and the two long suction slots 122 can be disposed on the same part of the air blowing and suction module 12 or respectively disposed on three separate parts of the air blowing and suction module 12.

Through the technical features of “a laser generating module 11 for providing a laser beam D,” “the laser generating module 11 includes a laser scanning writer 110 for providing a laser source L and a laser path adjuster 111 on the scanning path of the laser source L,” and “the cutting area A formed by projecting the laser beam D on the composite material 2 is offset parallel by the adjustment of the projecting of the laser beam D by the laser path adjuster 111, or the moving of the composite material 2 through the carrier substrate 10,” the cutting device 1 for cutting the composite material 2 provided by the present disclosure can form a plurality of the cutting area A at different positions on the composite material 2, and gradually deepen the depth of the cutting by repeated and continuing projecting of the laser beam D, so as to cut through the composite material 2.

Furthermore, the cutting device 1 for cutting a composite material of the present disclosure can carry the composite material 2 through the carrier substrate 10, repeatedly and continuously project the laser beam D to the composite material 2 on the carrier substrate 10 through the laser generating module 11, and form a plurality of cutting areas A on the composite material 2. The cutting device 1 according to the present disclosure adjusts the scanning path of the laser beam D by the laser path adjuster 111, or produces parallel offset of the composite material 2 relative to the laser generating module 11 through the carrier substrate 10, such that the cutting area A formed by the laser beam D being projected on the composite material 2 can be offset parallel, that is, forming the cutting area at the same or different position(s) on the composite material 2, so as to cut the composite material 2. Thereby, the cutting device 1 for cutting a composite material of the present disclosure can have better cutting efficiency and maintain better integrity of an object to be cut than conventional cutting devices and cutting methods.

### Eighth Embodiment

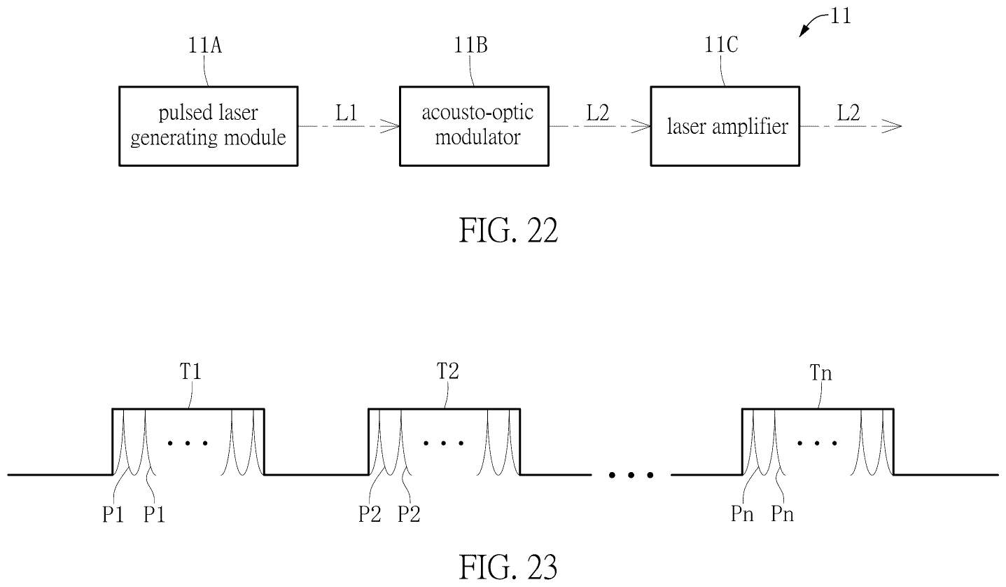

Referring to FIG. 22 and FIG. 23, the eighth embodiment of the present disclosure provides a cutting device (the same as the cutting device 1 of the first embodiment as shown in FIG. 1), which includes a carrier substrate 10 for carrying the composite material 2, and a laser generating module 11 disposed adjacent to the carrier substrate 10, in which the laser generating module 11 may include a pulsed laser generating module 11A, an acousto-optic modulator 11B adjacent to the pulsed laser generating module 11A, and a laser amplifier 11C adjacent to the acousto-optic modulator 11B. More particularly, the pulsed laser generating module 11A can be configured to generate a laser light source L1 (or laser light beam). The acousto-optic modulator 11B can be configured to increase a repetition frequency of the laser light source L1 and generate a pulsed laser beam L2 having a plurality of pulse trains (T1, T2, . . . Tn) based on the laser light source L1 with the increased repetition frequency. The laser amplifier 11C can be configured to increase a pulse energy of the pulsed laser beam L2.

Furthermore, when the pulsed laser beam L2 with the pulse trains (T1, T2, . . . Tn) is projected onto the composite material 2, a plurality of cutting areas A (as shown in FIG. 1) or drilling holes are formed on the composite material 2 by the pulsed laser beam L2 with the pulse trains (T1, T2, . . . Tn). Moreover, each of the pulse trains (T1, T2, . . . Tn) of the pulsed laser beam L2 includes a plurality of pulse signals (P1, P2, . . . Pn) that can be identical or different from each other, the number of the pulse signals (P1, P2, . . . Pn) in each of the pulse trains (T1, T2, . . . Tn) is between 50 and 1000, a pulse width of each of the pulse trains (T1, T2, . . . Tn) is between 50 and 500 fs, and a frequency of each of the pulse trains (T1, T2, . . . Tn) is between 1 and 2000 kHz. It should be noted that the pulse trains (T1, T2, . . . Tn) provided by the pulsed laser beam L2 can be configured to be identical or different according to the number of the pulse signals (P1, P2, . . . Pn) in each of the pulse trains (T1, T2, . . . Tn), and according to the pulse width and the frequency of each of the pulse trains (T1, T2, . . . Tn).

### Ninth Embodiment

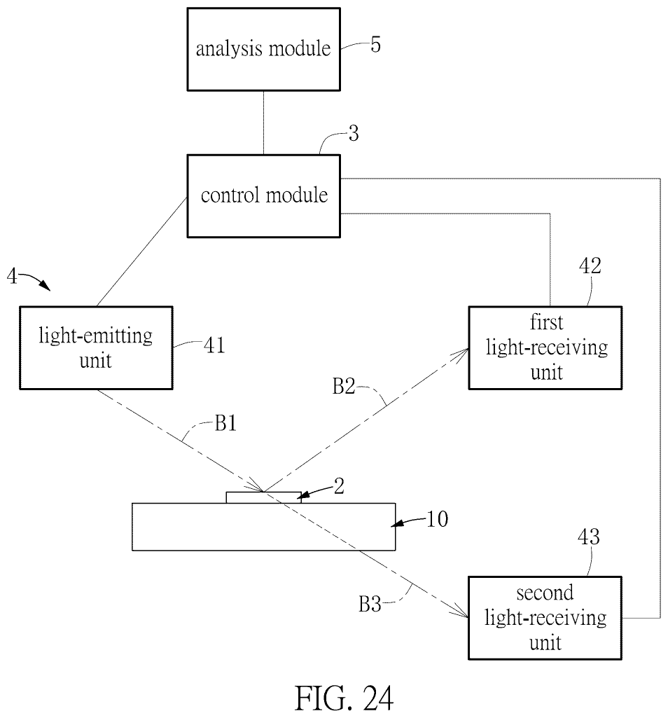

Referring to FIG. 24, the ninth embodiment of the present disclosure provides a cutting device (the same as the cutting device 1 of the first embodiment as shown in FIG. 1). The cutting device further includes a control module 3 and an optical detection module 4 (or optical inspection module) electrically connected to the control module 3 to monitor or detect the cutting areas or the drilling holes of the composite material 2. More particularly, the optical detection module 4 includes a light-emitting unit 41, a first light-receiving unit 42 and a second light-receiving unit 43 that are electrically connected to the control module 3. The light-emitting unit 41 and the first light-receiving unit 42 can be movably disposed above the carrier substrate 10, and the second light-receiving unit 43 can be movably disposed below the carrier substrate 10.

Furthermore, in one feasible embodiment, the first light-receiving unit 42 can be configured as one of a first wavefront sensor, a first photoelastic sensor, a first laser vibrometer and a first hyperspectral sensor, and the second light-receiving unit 43 can be configured as one of a second wavefront sensor, a second photoelastic sensor, a second laser vibrometer and a second hyperspectral sensor, according to different requirements. Moreover, the detection beam B1 generated by the light-emitting unit 41 can be projected onto a first detection area of the composite material 2 (such as any outer region on the composite material 2) to form a reflected beam B2 that can be received by the first light-receiving unit 42 to generate a first detection signal, or the detection beam B1 generated by the light-emitting unit 41 can pass through a second detection area of the composite material 2 (such as any inner region in the composite material 2) to form a through beam B3 (or transmitted light) that can be received by the second light-receiving unit 43 to generate a second detection signal. In addition, the cutting device further includes an analysis module 5 electrically connected to the control module 3 to analyze a first shadow portion of the first detection area (such as the outer region) that has not been irradiated by the light-emitting unit 41, or analyze a second shadow portion of the second detection area (such as the inner region) that has not been irradiated by the light-emitting unit 41.

### Tenth Embodiment

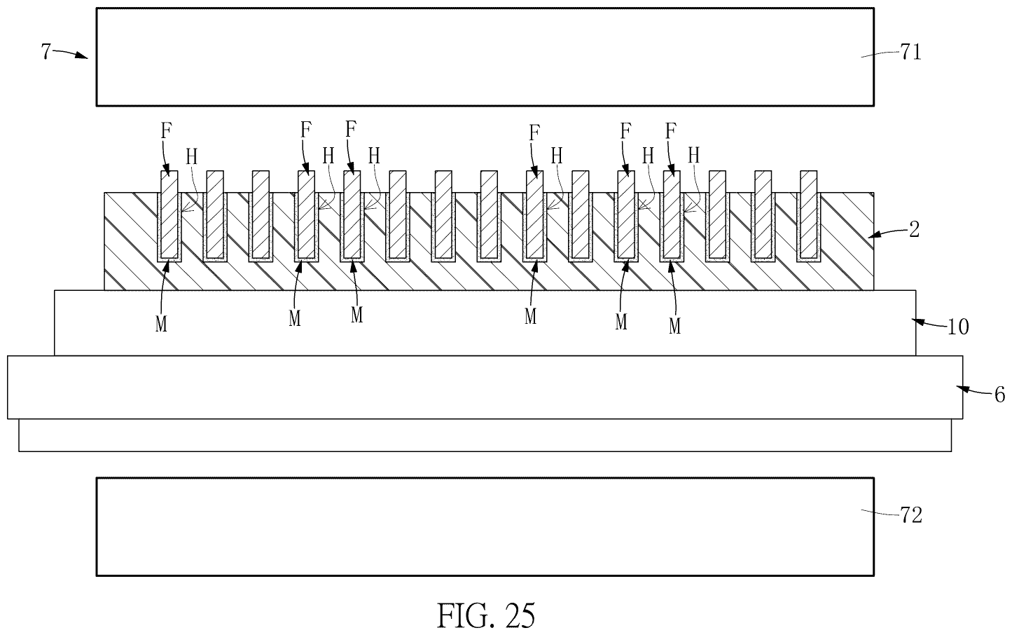

Referring to FIG. 25, the tenth embodiment of the present disclosure provides a cutting device (the same as the cutting device 1 of the first embodiment as shown in FIG. 1). When the cutting areas A (as shown in FIG. 1) or drilling holes H are formed on the composite material 2 by the pulsed laser beam with the pulse trains, each of the drilling holes H can partially or completely pass through the composite material 2 to form a through hole or a blind hole. It should be noted that each of the drilling holes H can be filled with a micro conductive pillar F (such as micro copper pillar) by cooperation of a vibration module 6 and a magnetic field generation module 7 (such as including a first magnetic field generation module 71 and a second magnetic field generation module 72) that are electrically connected to a control module, and the micro conductive pillar F can be fixed or positioned in the drilling hole H through an adhesive material M.

More particularly, in one feasible embodiment, the vibration module 6 can be configured to carry the carrier substrate 10 for accommodating the composite material 2. When the magnetic field generation module 7 is configured as the first magnetic field generation module 71, the first magnetic field generation module 71 can be configured to be movably disposed above the vibration module 6 for generating a first magnetic force to the micro conductive pillar F. When the magnetic field generation module 7 is configured as the second magnetic field generation module 72, the second magnetic field generation module 72 can be configured to be movably disposed below the vibration module 6 for generating a second magnetic force to the micro conductive pillar F. For example, the ratio of a depth to a diameter of each of the drilling holes H can range from 0.5 to 12. The diameter and the depth of each of the drilling holes H can be determined according to the number of the pulse trains and the pulse energy of the pulsed laser beam. The diameter of each of the drilling holes H can be between 10 μm and 50 μm, and the depth of each of the drilling holes H can be between 60 μm and 300 μm. The smoothness of the inner wall of each of the drilling holes H can be between 100 nm and 5000 nm.

The foregoing description of the exemplary embodiments of the present disclosure has been presented only for the purposes of illustration and description and is not intended to be exhaustive or to limit the present disclosure to the precise forms disclosed. Many modifications and variations are possible in light of the above teaching.

Certain embodiments were chosen and described in order to explain the principles of the present disclosure and their practical application so as to enable others skilled in the art to utilize the present disclosure and various embodiments and with various modifications as are suited to the particular use contemplated. Alternative embodiments will become apparent to those skilled in the art to which the present disclosure pertains without departing from its spirit and scope.

What is claimed is:

1. A cutting device for cutting a composite material, comprising:
a carrier substrate for carrying the composite material; and
a laser generating module disposed adjacent to the carrier substrate, wherein the laser generating module includes a pulsed laser generating module, an acousto-optic modulator adjacent to the pulsed laser generating module, and a laser amplifier adjacent to the acousto-optic modulator;
wherein the pulsed laser generating module is configured to generate a laser light source;
wherein the acousto-optic modulator is configured to increase a repetition frequency of the laser light source and generate a pulsed laser beam having a plurality of pulse trains based on the laser light source with the increased repetition frequency;
wherein the laser amplifier is configured to increase a pulse energy of the pulsed laser beam;
wherein, when the pulsed laser beam with the pulse trains is projected onto the composite material, a plurality of cutting areas or drilling holes are formed on the composite material by the pulsed laser beam with the pulse trains;
wherein each of the pulse trains of the pulsed laser beam includes a plurality of pulse signals, the number of the pulse signals in each of the pulse trains is between 50 and 1000, a pulse width of each of the pulse trains is between 50 and 500 fs, and a frequency of each of the pulse trains is between 1 and 2000 kHz;
wherein the pulse trains provided by the pulsed laser beam are configured to be identical or different according to the number of the pulse signals in each of the pulse trains, and the pulse width and the frequency of each of the pulse trains.

2. The cutting device for cutting the composite material according to claim 1,
wherein each of the drilling holes passes through the composite material to form a through hole or a blind hole;
wherein a diameter and a depth of each of the drilling holes is determined according to the number of the pulse trains and the pulse energy of the pulsed laser beam;
wherein the diameter of each of the drilling holes is between 10 μm and 50 μm, and the depth of each of the drilling holes is between 60 μm and 300 μm; and
wherein a smoothness of an inner wall of each of the drilling holes is between 100 nm and 5000 nm.

3. The cutting device for cutting the composite material according to claim 1,
wherein the cutting device further comprises a control module and an optical detection module electrically connected to the control module to monitor the cutting areas or the drilling holes of the composite material;
wherein the optical detection module includes a light-emitting unit, a first light-receiving unit and a second light-receiving unit that are electrically connected to the control module;
wherein the light-emitting unit and the first light-receiving unit are movably disposed above the carrier substrate, and the second light-receiving unit is movably disposed below the carrier substrate;
wherein the first light-receiving unit is configured as one of a first wavefront sensor, a first photoelastic sensor, a first laser vibrometer and a first hyperspectral sensor, and the second light-receiving unit is configured as one of a second wavefront sensor, a second photoelastic sensor, a second laser vibrometer and a second hyperspectral sensor;
wherein a detection beam generated by the light-emitting unit is projected onto a first detection area of the composite material to form a reflected beam that is received by the first light-receiving unit to generate a first detection signal, or passes through a second detection area of the composite material to form a through beam that is received by the second light-receiving unit to generate a second detection signal; and
wherein the cutting device further comprises an analysis module electrically connected to the control module to analyze a first shadow portion of the first detection area that has not been irradiated by the light-emitting unit, or analyze a second shadow portion of the second detection area that has not been irradiated by the light-emitting unit.

4. The cutting device for cutting the composite material according to claim 1,
wherein the ratio of a depth to a diameter of each of the drilling holes ranges from 0.5 to 12:
wherein each of the drilling holes is filled with a micro conductive pillar by cooperation of a vibration module and a magnetic field generation module that are electrically connected to a control module;
wherein the micro conductive pillar is fixed in the drilling hole through an adhesive material;
wherein the vibration module is configured to carry the carrier substrate for accommodating the composite material, and the magnetic field generation module is configured to be movably disposed above or below the vibration module for generating a magnetic force to the micro conductive pillar.

5. The cutting device for cutting the composite material according to claim 1,
wherein the cutting areas formed on the composite material extend along a predetermined direction;
wherein the cutting device further comprises an air blowing and suction module having a long blowing outlet configured to blow air to the cutting areas, and a long suction inlet configured to suction the air from the cutting areas at the same time;
wherein the air blowing and suction module is configured to be separated from the composite material without directly or indirectly causing movement of the composite material;
wherein the long blowing outlet and the long suction inlet are adjacent to each other, and a length of the long blowing outlet and a length of the long suction inlet are greater than a maximum distance between two of the cutting areas that are farthest apart along the predetermined direction;
wherein the length of the long blowing outlet and the length of the long suction inlet are greater than a length of the composite material;
wherein the air blowing and suction module has a first air channel in air communication with the long blowing outlet and an air supply device, and a second air channel in air communication with the long suction inlet and a suction pump, and a dust collector is in air communication with the second air channel and the suction pump;
wherein the cutting area has a groove recessed from a top surface of the composite material, the long blowing outlet of the air blowing and suction module is configured to blow the air into the groove of each of the cutting areas so as to blow particles out of the groove of each of the cutting areas, and the long suction inlet of the air blowing and suction module is configured to suction the air with the particles from the groove of each of the cutting areas;
wherein the length of the long blowing outlet and the length of the long suction inlet are the same or different;
wherein the air blowing and suction module has another long blowing outlet configured to blow the air to the cutting areas, the long suction inlet is disposed between the two long blowing outlets, and a length of the another long blowing outlet is greater than the maximum distance between the two cutting areas;
wherein the air blowing and suction module has another long suction inlet configured to suction the air from the cutting areas, the long blowing outlet is disposed between the two long suction inlets, and a length of the another long suction inlet is greater than the maximum distance between the two cutting areas;
wherein the composite material includes a semiconductor wafer, and the semiconductor wafer has a thickness less than 100 μm; and
wherein the composite material includes at least one of an oxide layer, a nitride layer and a carbonization layer.

6. A cutting device for cutting a composite material, comprising:
a carrier substrate for carrying the composite material; and
a laser generating module disposed adjacent to the carrier substrate, wherein the laser generating module includes a pulsed laser generating module, an acousto-optic modulator adjacent to the pulsed laser generating module, and a laser amplifier adjacent to the acousto-optic modulator;
wherein the pulsed laser generating module is configured to generate a laser light source;
wherein the acousto-optic modulator is configured to increase a repetition frequency of the laser light source and generate a pulsed laser beam having a plurality of pulse trains based on the laser light source with the increased repetition frequency;
wherein the laser amplifier is configured to increase a pulse energy of the pulsed laser beam;
wherein, when the pulsed laser beam with the pulse trains is projected onto the composite material, a plurality of cutting areas or drilling holes are formed on the composite material by the pulsed laser beam with the pulse trains;
wherein each of the pulse trains of the pulsed laser beam includes a plurality of pulse signals;
wherein the pulse trains provided by the pulsed laser beam are configured to be identical or different according to the number of the pulse signals in each of the pulse trains, and a pulse width and a frequency of each of the pulse trains.

7. The cutting device for cutting the composite material according to claim 6,
wherein each of the drilling holes passes through the composite material to form a through hole or a blind hole;
wherein a diameter and a depth of each of the drilling holes is determined according to the number of the pulse trains and the pulse energy of the pulsed laser beam;
wherein the diameter of each of the drilling holes is between 10 μm and 50 μm, and the depth of each of the drilling holes is between 60 μm and 300 μm; and
wherein a smoothness of an inner wall of each of the drilling holes is between 100 nm and 5000 nm.

8. The cutting device for cutting the composite material according to claim 6,
wherein the cutting device further comprises a control module and an optical detection module electrically connected to the control module to monitor the cutting areas or the drilling holes of the composite material;
wherein the optical detection module includes a light-emitting unit, a first light-receiving unit and a second light-receiving unit that are electrically connected to the control module;
wherein the light-emitting unit and the first light-receiving unit are movably disposed above the carrier substrate, and the second light-receiving unit is movably disposed below the carrier substrate;
wherein the first light-receiving unit is configured as one of a first wavefront sensor, a first photoelastic sensor, a first laser vibrometer and a first hyperspectral sensor, and the second light-receiving unit is configured as one of a second wavefront sensor, a second photoelastic sensor, a second laser vibrometer and a second hyperspectral sensor;
wherein a detection beam generated by the light-emitting unit is projected onto a first detection area of the composite material to form a reflected beam that is received by the first light-receiving unit to generate a first detection signal, or passes through a second detection area of the composite material to form a through beam that is received by the second light-receiving unit to generate a second detection signal; and
wherein the cutting device further comprises an analysis module electrically connected to the control module to analyze a first shadow portion of the first detection area that has not been irradiated by the light-emitting unit, or analyze a second shadow portion of the second detection area that has not been irradiated by the light-emitting unit.

9. The cutting device for cutting the composite material according to claim 6,
wherein the ratio of a depth to a diameter of each of the drilling holes ranges from 0.5 to 12:
wherein each of the drilling holes is filled with a micro conductive pillar by cooperation of a vibration module and a magnetic field generation module that are electrically connected to a control module;
wherein the micro conductive pillar is fixed in the drilling hole through an adhesive material;
wherein the vibration module is configured to carry the carrier substrate for accommodating the composite material, and the magnetic field generation module is configured to be movably disposed above or below the vibration module for generating a magnetic force to the micro conductive pillar.

10. The cutting device for cutting the composite material according to claim 6,
wherein the cutting areas formed on the composite material extend along a predetermined direction;
wherein the cutting device further comprises an air blowing and suction module having a long blowing outlet configured to blow air to the cutting areas, and a long suction inlet configured to suction the air from the cutting areas at the same time;
wherein the air blowing and suction module is configured to be separated from the composite material without directly or indirectly causing movement of the composite material;
wherein the long blowing outlet and the long suction inlet are adjacent to each other, and a length of the long blowing outlet and a length of the long suction inlet are greater than a maximum distance between two of the cutting areas that are farthest apart along the predetermined direction;
wherein the length of the long blowing outlet and the length of the long suction inlet are greater than a length of the composite material;
wherein the air blowing and suction module has a first air channel in air communication with the long blowing outlet and an air supply device, and a second air channel in air communication with the long suction inlet and a suction pump, and a dust collector is in air communication with the second air channel and the suction pump;
wherein the cutting area has a groove recessed from a top surface of the composite material, the long blowing outlet of the air blowing and suction module is configured to blow the air into the groove of each of the cutting areas so as to blow particles out of the groove of each of the cutting areas, and the long suction inlet of the air blowing and suction module is configured to suction the air with the particles from the groove of each of the cutting areas;
wherein the length of the long blowing outlet and the length of the long suction inlet are the same or different;
wherein the air blowing and suction module has another long blowing outlet configured to blow the air to the cutting areas, the long suction inlet is disposed between the two long blowing outlets, and a length of the another long blowing outlet is greater than the maximum distance between the two cutting areas;
wherein the air blowing and suction module has another long suction inlet configured to suction the air from the cutting areas, the long blowing outlet is disposed between the two long suction inlets, and a length of the another long suction inlet is greater than the maximum distance between the two cutting areas;
wherein the composite material includes a semiconductor wafer, and the semiconductor wafer has a thickness less than 100 μm; and
wherein the composite material includes at least one of an oxide layer, a nitride layer and a carbonization layer.
